(19) United States
(12) Patent Application Publication
(10) Pub. No.: US 2026/0320345 A1
(43) Pub. Date: Oct. 15, 2026

(54) ACTIVE OFFLINE POLICY SELECTION USING POLICY REPRESENTATIONS

(71) Applicant: GDM HOLDING LLC, Mountain View, CA (US)

(72) Inventors: Misha Man Ray Denil, London (GB); Ksenia Konyushkova, London (GB); Gianluca Scarpellini, Orio al Serio (IT)

(21) Appl. No.: 19/485,078

(22) PCT Filed: May 15, 2024
(86) PCT No.: PCT/EP2024/063399

§ 371 Date: Nov. 17, 2025

Related U.S. Application Data
(60) Provisional application No. 63/467,286, filed on May 17, 2023.

(51) Int. Cl. G06N 3/02

(52) U.S. Cl. CPC G06N 3/02

(57) ABSTRACT

Methods, systems, and apparatus, including computer programs encoded on computer storage media, for obtaining one or more final policies for controlling an agent in an environment. In one aspect, one of the methods include: obtaining a candidate policy set that includes a plurality of candidate policies for controlling an agent in an environment; obtaining an offline dataset that stores a plurality of history trajectories, wherein each history trajectory comprises a plurality of history observations that each characterize a respective history state of the environment; and generating a behavioral representation for each candidate policy.

### CROSS-REFERENCE TO RELATED APPLICATION

This application claims priority to U.S. Provisional Application No. 63/467,286, filed on May 17, 2023. The disclosure of the prior application is considered part of and is incorporated by reference in the disclosure of this application.

### BACKGROUND

This specification relates to controlling agents using neural networks.

Neural networks are machine learning models that employ one or more layers of nonlinear units to predict an output for a received input. Some neural networks are deep neural networks that include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that obtains one or more final action selection policies (or “final policies” for short) for controlling an agent in an environment.

According to an aspect, there is provided a computer-implemented method comprising: obtaining a candidate policy set comprising a plurality of candidate policies for controlling an agent in an environment; obtaining an offline dataset that stores a plurality of history trajectories, wherein each history trajectory comprises a plurality of history observations that each characterize a respective history state of the environment; and generating a behavioral representation for each candidate policy, comprising, for each candidate policy: for each of a subset of the plurality of history observations, generating a successor feature value for the history observation under the candidate policy by using a successor feature neural network that corresponds to the candidate policy, wherein the successor feature neural network is configured to receive a successor feature network input comprising the history observation and a respective action selected by using the candidate policy to be performed by the agent in response to the history observation, and to process the successor feature network input to generate the successor feature value of the history observation; generating a feature vector for the candidate policy based on the successor feature values that have been generated for one or more of the subset of the plurality of history observations; and determining the behavioral representation for the candidate policy from the feature vector for the candidate policy.

Generating the feature vector for the candidate policy may comprise computing an average of the successor feature values that have been generated for one or more of the subsets of the plurality of history observations.

The method may further comprise: determining, based on the behavioral representation for each candidate policy, an estimated performance measure for each candidate policy.

Determining the estimated performance measure for each candidate policy may comprise: processing the behavioral representation for the candidate policy using a learned model to generate, as the estimated performance measure, an estimated return of the candidate policy.

The plurality of candidate policies may comprise at least one already evaluated candidate policy, and wherein determining the estimated performance measure for each candidate policy may comprise, for each remaining candidate policy that has not been evaluated: determining the estimated performance measure for the remaining candidate policy based on (a) a difference between (i) a behavioral representation for the remaining candidate policy and (ii) a behavioral representation for the already evaluated candidate policy and on (b) a known performance measure of the already evaluated candidate policy.

The plurality of candidate policies may comprise a larger number of candidate policies that have not been evaluated than already evaluated candidate policies.

The method may further comprise: obtaining, based on the estimated performance measure for each candidate policy, a final policy to control the agent in the environment.

Obtaining the final policy to control the agent in the environment may comprise: selecting a subset of the plurality of candidate policies based on their estimated performance measures; determining an actual performance measure for each candidate policy in the subset by using the candidate policy to control the agent in the environment, including selecting a sequence of actions to be performed by the agent in accordance with the candidate policy; and selecting, based on the actual performance measures, a candidate policy as the final policy.

Obtaining the final policy to control the agent in the environment may comprise: receiving a current observation characterizing a current state of the environment; generating, based on applying a generalized policy improvement algorithm to the plurality of candidate policies, the final policy; and selecting a current action to be performed by the agent in response to the current observation in accordance with the final policy.

The method may further comprise training different successor feature neural networks that correspond to different candidate policies by using an encoder neural network and by using the offline dataset.

Training a successor feature neural network that corresponds to a candidate policy may comprise: obtaining from the offline dataset a training history trajectory that comprises a sequence of history observations; processing each history observation in the sequence of history observations that begins from a given history observation using the encoder neural network to generate a respective encoded representation of the history observation; processing the given history observation in the sequence of history observations using the successor feature neural network to generate a successor feature value for the given history observation; evaluating a loss function that measures a difference between (i) the successor feature value for the given history observation and (ii) a time-discounted sum of the respective encoded representations of the sequence of history observations that begins from the given history observation; and determining, based on computing a gradient of the loss function with respect to parameters of the successor feature neural network, one or more updates to current values of the parameter of the successor feature neural network.

The encoder neural network may comprise one of: a convolutional neural network having randomly initialized or learned parameter values; an image encoder in an image-text neural network pre-trained on an image caption task; a visual Transformer neural network pre-trained on an image classification task; or a neural network pre-trained on a video tracking task.

According to another aspect, there is provided a computer-implemented method comprising: obtaining data specifying a pre-trained model; maintaining an offline dataset that stores a plurality of history trajectories, wherein each history trajectory comprises a plurality of history observations that each characterize a respective history state of an environment; and training a successor feature neural network that corresponds to a candidate policy by using the pre-trained model and the offline dataset, wherein the training may comprise: from the offline dataset a training history trajectory that comprises a sequence of history observations; for each history observation in the sequence of history observations that begins from a given history observation, processing a model input comprising the history observation using the pre-trained model to generate a respective encoded representation of the history observation; processing a successor feature network input comprising (i) the given history observation in the sequence of history observations and (ii) an action selected using the candidate policy in response to the given history observation using the successor feature neural network to generate a successor feature value for the given history observation; evaluating a loss function that measures a difference between (i) the successor feature value for the given history observation and (ii) a time-discounted sum of the respective encoded representations of the sequence of history observations that begins from the given history observation; and determining, based on computing a gradient of the loss function with respect to parameters of the successor feature neural network, one or more updates to current values of the parameter of the successor feature neural network.

The method may further comprise using the trained successor feature neural network to generate a behavioral representation of the candidate policy.

The method may further comprise using the behavioral representation of the candidate policy to determine whether to deploy the candidate policy for controlling an agent in the environment or whether to use the candidate policy to generate a final policy for controlling the agent.

The pre-trained model may comprise a pre-trained visual model.

The agent may be a mechanical agent and the environment may be a real-world environment.

The agent may be a robot.

The environment may be a real-world environment of a service facility comprising a plurality of items of electronic equipment and the agent may be an electronic agent configured to control operation of the service facility.

The environment may be a real-world manufacturing environment for manufacturing a product and the agent may comprise an electronic agent configured to control a manufacturing unit or a machine that operates to manufacture the product.

The environment may be a simulation of a real-world environment and wherein the method may further comprise: after generating the final policy, providing data specifying the final policy for use in controlling a real-world agent in the real-world environment.

According to another aspect, there is provided one or more computer-readable storage media encoded with instructions that, when executed by one or more computers, cause the one or more computers to perform the operations of the above method aspects.

According to a further aspect, there is provided a system comprising one or more computers and one or more storage devices storing instructions that when executed by one or more computers cause the one or more computers to perform the respective operations of the above method aspects.

The subject matter described in this specification can be implemented in particular embodiments so as to realize one or more of the following advantages.

High performing policies that can be used to select actions to be performed by an agent interacting with an environment to perform a task with a high performance (e.g., a higher long-term time discounted reward received by the agent while performing the task) can be effectively selected. In particular, a relatively small number of high performing policies can be identified even when there exists a very large number of candidate policies such that individually trying out each candidate policy in order to decide which ones to use to control the agent is impractical, such as when the system do not have access to the agent, or when online environment interaction might take too much time and/or computing resources or might cause damage or wear and tear to the agent.

By using different successor feature neural networks, such as can be generated using e.g., a common, policy agnostic foundation model, to generate behavioral representations for different candidate policies, the system described in this specification can automatically and accurately assess the performance of the collection of candidate policies by using mostly logged data and with minimal online environment interaction. In particular, the behavioral representations generated by the successor feature neural networks can characterize how each of the candidate policies changes the environment by modelling the expected future occurrence of states of the environment, given history observations of the environment, if the candidate policy is followed.

In particular, repeatedly evaluating the performance of all candidate policies by way of actual deployment on an agent is no longer required; instead, the system may only need to evaluate a relatively small number of candidate policies that have been selected based on their behavioral representations. In practice, the described system is very useful in many technical use cases, e.g., industrial or robotic tasks, particularly where there exists abundant logged data (e.g., demonstration data or past experience data), but with a restricted online interaction budget, e.g., due to the lengthy time or high hardware cost that is required for repeated deployment of different candidate policies on an agent. From another point of view, this improvement in evaluation efficiency makes it possible to quickly and effectively explore a more diverse pool of candidate policies to obtain a better final policy.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example agent control system and an example policy evaluation system.

FIG. 2 is an example illustration of operations performed by a policy evaluation system.

FIG. 3 is an example illustration of an architecture of a successor feature neural network.

FIG. 4 is a flow diagram of an example process for obtaining a final policy to control an agent in an environment.

FIG. 5 is a flow diagram of sub-steps of one of the steps of the process of FIG. 4.

FIG. 6 is a flow diagram of sub-steps of one of the steps of the process of FIG. 4.

FIG. 7 is a flow diagram of an example process for training a successor feature neural network.

FIG. 8 is an example illustration of training a successor feature neural network.

Like reference numbers and designations in the various drawings indicate like elements.

### DETAILED DESCRIPTION

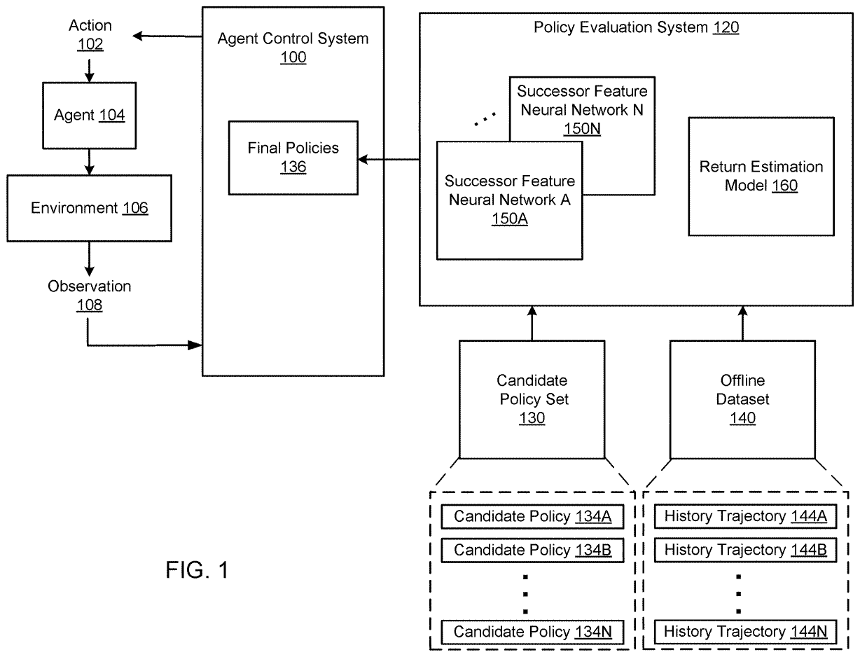

FIG. 1 shows an example agent control system 100 and an example policy evaluation system 120. The agent control system 100 and the policy evaluation system 120 are examples of a system implemented as computer programs on one or more computers in one or more locations in which the systems, components, and techniques described below are implemented.

The agent control system 100 uses one or more final action selection policies 136 (or “final policies” for short) to select actions 102 to be performed by an agent 104 interacting with an environment 106 at each of multiple successive time steps. At each time step, the system 100 receives data characterizing the current state of the environment 106 and selects an action 102 to be performed by the agent 104 in response to the received data in accordance with the one or more final policies 136.

Each final policy 136 defines which action should be performed by the agent at each of multiple time steps (according to the final policy). Data characterizing a state of the environment 106, e.g., an image of the environment 106, will be referred to in this specification as an observation 108.

Once the agent control system 100 selects an action to be performed by the agent 104, the agent control system 100 can cause the agent 104 to perform the selected action. In other words, the agent control system 100 can use the one or more final policies 136 to control the agent 104 to automatically perform a particular task without any user intervention.

For example, the system 100 can instruct the agent 104 and the agent 104 can perform the selected action. As another example, the system 100 can directly generate control signals for one or more controllable elements of the agent 104. As yet another example, the system 100 can transmit data specifying the selected action to a control system of the agent 104, which controls the agent 104 to perform the action.

Generally, the agent 104 performing the selected action results in the environment 106 transitioning into a different state. By repeatedly causing the agent 102 to act in the environment 106, the agent control system 100 can control the agent 104 to complete a particular task.

The agent control system 100 described herein is widely applicable and is not limited to one specific implementation. However, for illustrative purposes, a small number of example implementations are described below.

In some implementations, the environment 106 is a real-world environment, the agent 104 is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the mechanical agent, e.g. robot, may be interacting with the environment to accomplish a specific task, e.g., to locate or manipulate an object of interest in the environment or to move an object of interest to a specified location in the environment or to navigate to a specified destination in the environment.

In these implementations, the observations 108 may include, e.g., one or more of: images, object position data, and sensor data to capture observations as the agent interacts with the environment, for example sensor data from an image, distance, or position sensor or from an actuator. For example in the case of a robot, the observations 108 may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations 108 may similarly include one or more of the position, linear or angular velocity, force, torque or acceleration, and global or relative pose of one or more parts of the agent. The observations 100 may be defined in 1, 2 or 3 dimensions, and may be absolute and/or relative observations. The observations 100 may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions 102 may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

In some implementations the environment 106 is a simulation of the above-described real-world environment, and the agent 104 is implemented as one or more computers interacting with the simulated environment. For example the simulated environment may be a simulation of a robot or vehicle and the agent control system 100 may be trained on the simulation and then, once trained, used in the real-world.

In some implementations the environment 106 is a real-world manufacturing environment for manufacturing a product, such as a chemical, biological, or mechanical product, or a food product. As used herein “manufacturing” a product also includes refining a starting material to create a product, or treating a starting material e.g. to remove pollutants, to generate a cleaned or recycled product. The manufacturing plant may comprise a plurality of manufacturing units such as vessels for chemical or biological substances, or machines, e.g. robots, for processing solid or other materials. The manufacturing units are configured such that an intermediate version or component of the product is moveable between the manufacturing units during manufacture of the product, e.g. via pipes or mechanical conveyance. As used herein manufacture of a product also includes manufacture of a food product by a kitchen robot.

The agent 104 may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent 104 may comprise a task to manufacture the product or an intermediate version or component thereof. As another example, a task performed by the agent may comprise a task to control, e.g. minimize, use of a resource such as a task to control electrical power consumption, or water consumption, or the consumption of any material or consumable used in the manufacturing process.

The actions 102 may comprise control actions to control the use of a machine or a manufacturing unit for processing a solid or liquid material to manufacture the product, or an intermediate or component thereof, or to control movement of an intermediate version or component of the product within the manufacturing environment e.g. between the manufacturing units or machines. In general the actions may be any actions that have an effect on the observed state of the environment, e.g. actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g. a metric of a quantity of energy, materials, or other resources, used to perform the task. In the case of a task that is to control use of a resource the metric may comprise any metric of usage of the resource.

In general observations 108 of a state of the environment 106 may comprise any electronic signals representing the functioning of electronic and/or mechanical items of equipment. For example a representation of the state of the environment may be derived from observations made by sensors sensing a state of the manufacturing environment, e.g. sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment 106 is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g. cooling equipment, or air flow control or air conditioning equipment such as a heater, a cooler, a humidifier, or other hardware that modifies a property of air in the real-world environment. The task may comprise a task to control, e.g. minimize, use of a resource, such as a task to control electrical power consumption, or water consumption. The agent 104 may comprise an electronic agent configured to control operation of the items of equipment, or to control operation of the ancillary, e.g. environmental, control equipment.

In general the actions 102 may be any actions that have an effect on the observed state of the environment, e.g. actions configured to adjust any of the sensed parameters described below. These may include actions to control, or to impose operating conditions on, the items of equipment or the ancillary control equipment, e.g. actions that result in changes to settings to adjust, control, or switch on or off the operation of an item of equipment or an item of ancillary control equipment.

In general observations 108 of a state of the environment 106 may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g. minimize, use of a resource, such as a task to control use of electrical power or water, the metric may comprise any metric of use of the resource.

In some implementations the environment 106 is the real-world environment of a power generation facility e.g. a renewable power generation facility such as a solar farm or wind farm. The task may comprise a control task to control power generated by the facility, e.g. to control the delivery of electrical power to a power distribution grid, e.g. to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements e.g. to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g. an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations 108 of a state of the environment 106 may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such observations may thus include observations of wind levels or solar irradiance, or of local time, date, or season. Such sensors may include sensors configured to sense electrical conditions of the equipment such as current, voltage, power or energy; temperature or cooling of the physical environment; fluid flow; or a physical configuration of the equipment; and observations of an electrical condition of the grid e.g. from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that indirectly performs or controls the protein folding actions, or chemical synthesis steps, e.g. by controlling synthesis steps selected by the system automatically without human interaction. The observations may comprise direct or indirect observations of a state of the protein or chemical/intermediates/precursors and/or may be derived from simulation. Thus the system may be used to automatically synthesize a protein with a particular function such as having a binding site shape, e.g. a ligand that binds with sufficient affinity for a biological effect that it can be used as a drug. For example e.g. it may be an agonist or antagonist of a receptor or enzyme; or it may be an antibody configured to bind to an antibody target such as a virus coat protein, or a protein expressed on a cancer cell, e.g. to act as an agonist for a particular receptor or to prevent binding of another ligand and hence prevent activation of a relevant biological pathway.

In a similar way the environment 106 may be a drug design environment such that each state is a respective state of a potential pharmaceutically active compound, i.e. a drug, and the agent is a computer system for determining elements of the pharmaceutically active compound and/or a synthetic pathway for the pharmaceutically active compound. The drug/synthesis may be designed based on a reward derived from a target for the pharmaceutically active compound, for example in simulation. The agent 104 may be, or may include, a mechanical agent that performs or controls synthesis of the pharmaceutically active compound; and hence a process as described herein may include making such a pharmaceutically active compound.

For example the environment 106 may be an in silico drug design environment, e.g., a molecular docking environment, and the agent 104 may be a computer system for determining elements or a chemical structure of the drug. The drug may be a small molecule or biologic drug. An observation 108 may be an observation of a simulated combination of the drug and a target of the drug. An action may be an action to modify the relative position, pose or conformation of the drug and drug target (or this may be performed automatically) and/or an action to modify a chemical composition of the drug and/or to select a candidate drug from a library of candidates. One or more rewards may be defined based on one or more of: a measure of an interaction between the drug and the drug target, e.g., of a fit or binding between the drug and the drug target; an estimated potency of the drug; an estimated selectivity of the drug; an estimated toxicity of the drug; an estimated pharmacokinetic characteristic of the drug; an estimated bioavailability of the drug; an estimated ease of synthesis of the drug; and one or more fundamental chemical properties of the drug. A measure of interaction between the drug and drug target may depend on e.g. a protein-ligand bonding, van der Waals interactions, electrostatic interactions, and/or a contact surface region or energy; it may comprise, e.g., a docking score. Following identification of elements or a chemical structure of a drug in simulation, the method may further comprise making the drug. The drug may be made partly or completely by an automatic chemical synthesis system.

In some applications the agent 104 may be a software agent i.e. a computer program, configured to perform a task. For example the environment 106 may be a circuit or an integrated circuit design or routing environment and the agent may be configured to perform a design or routing task for routing interconnection lines of a circuit or of an integrated circuit e.g. an ASIC. The reward(s) may then be dependent on one or more routing metrics such as interconnect length, resistance, capacitance, impedance, loss, speed or propagation delay; and/or physical line parameters such as width, thickness or geometry, and design rules. The reward(s) may also or instead include one or more reward(s) relating to a global property of the routed circuitry e.g. component density, operating speed, power consumption, material usage, a cooling requirement, level of electromagnetic emissions, and so forth. The observations may be e.g. observations of component positions and interconnections; the actions may comprise component placing actions e.g. to define a component position or orientation and/or interconnect routing actions e.g. interconnect selection and/or placement actions. The task may be, e.g., to optimize circuit operation to reduce electrical losses, local or external interference, or heat generation, or to increase operating speed, or to minimize or optimize usage of available circuit area. The method may include making the circuit or integrated circuit to the design, or with interconnection lines routed as determined by the method.

In some applications the agent 104 is a software agent and the environment is a real-world computing environment. In one example the agent manages distribution of tasks across computing resources e.g. on a mobile device and/or in a data center. In these applications, the observations may include observations of computing resources such as compute and/or memory capacity, or Internet-accessible resources; and the actions may include assigning tasks to particular computing resources. The reward(s) may be configured to maximize or minimize one or more of: utilization of computing resources, electrical power, bandwidth, and computation speed.

In another example the software agent manages the processing, e.g. by one or more real-world servers, of a queue of continuously arriving jobs. The observations may comprise observations of the times of departures of successive jobs, or the time intervals between the departures of successive jobs, or the time a server takes to process each job, e.g. the start and end of a range of times, or the arrival times, or time intervals between the arrivals, of successive jobs, or data characterizing the type of job(s). The actions 102 may comprise actions that allocate particular jobs to particular computing resources; the reward(s) may be configured to minimize an overall queueing or processing time or the queueing or processing time for one or more individual jobs, or in general to optimize any metric based on the observations.

As another example the environment 106 may comprise a real-world computer system or network, the observations 108 may comprise any observations characterizing operation of the computer system or network, the actions performed by the software agent may comprise actions to control the operation e.g. to limit or correct abnormal or undesired operation e.g. because of the presence of a virus or other security breach, and the reward(s) may comprise any metric(s) that characterizing desired operation of the computer system or network.

In some applications, the environment 106 is a real-world computing environment and the software agent manages distribution of tasks/jobs across computing resources e.g. on a mobile device and/or in a data center. In these implementations, the observations 108 may comprise observations that relate to the operation of the computing resources in processing the tasks/jobs, the actions may include assigning tasks/jobs to particular computing resources, and the reward(s) may relate to one or more metrics of processing the tasks/jobs using the computing resources, e.g. metrics of usage of computational resources, bandwidth, or electrical power, or metrics of processing time, or numerical accuracy, or one or more metrics that relate to a desired load balancing between the computing resources.

In some applications the environment is a data packet communications network environment, and the agent is part of a router to route packets of data over the communications network. The actions may comprise data packet routing actions and the observations may comprise e.g. observations of a routing table which includes routing metrics such as a metric of routing path length, bandwidth, load, hop count, path cost, delay, maximum transmission unit (MTU), and reliability. The reward(s) may be defined in relation to one or more of the routing metrics i.e. configured to maximize one or more of the routing metrics.

In some other applications the environment is an Internet or mobile communications environment and the agent is a software agent which manages a personalized recommendation for a user. The observations may comprise previous actions taken by the user, e.g. features characterizing these; the actions may include actions recommending items such as content items to a user. The reward(s) may be configured to maximize one or more of: an estimated likelihood that the user will respond favorably to being recommended the (content) item, a suitability unsuitability of one or more recommended items, a cost of the recommended item(s), and a number of recommendations received by the user, optionally within a time span.

As a further example, the actions 102 may include presenting advertisements, the observations 108 may include advertisement impressions or a click-through count or rate, and the reward may characterize previous selections of items or content taken by one or more users.

In some cases, the observations 108 may include textual or spoken instructions provided to the agent by a third-party (e.g., an operator of the agent). For example, the agent 104 may be an autonomous vehicle, and a user of the autonomous vehicle may provide textual or spoken instructions to the agent (e.g., to navigate to a particular location).

As another example the environment 106 may be an electrical, mechanical or electro-mechanical design environment, e.g. an environment in which the design of an electrical, mechanical or electro-mechanical entity is simulated. The simulated environment may be a simulation of a real-world environment in which the entity is intended to work. The task may be to design the entity. The observations 108 may comprise observations that characterize the entity, i.e. observations of a mechanical shape or of an electrical, mechanical, or electro-mechanical configuration of the entity, or observations of parameters or properties of the entity. The actions 102 may comprise actions that modify the entity e.g. that modify one or more of the observations. The rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g. in the form of computer executable instructions for manufacturing the entity. The process may include making the entity according to the design. Thus the design of an entity may be optimized, e.g. by reinforcement learning, and then the optimized design output for manufacturing the entity, e.g. as computer executable instructions; an entity with the optimized design may then be manufactured.

As previously described the environment 106 may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

In some implementations the observations 108 are observations of a real-world environment in which a human is performing a task, e.g. an image observation from an image sensor and/or a language observation from a speech recognition system; and the actions are language actions that control (instruct) the human, e.g. using natural language or images, to perform actions in the real-world environment to perform the task. A language action may be an action that outputs a natural language sentence, e.g. by defining a sequence of language tokens, e.g. words or wordpieces, to be emitted at sequential time steps.

Thus the agent 104 may comprise a user interface device such as a digital device (a “digital assistant”), e.g. a smart speaker or smart display or other device, e.g. with a natural language input and/or output, that controls (instructs) a human user to perform a task. In general such a digital device can be a mobile device with a natural language interface to receive natural language requests from a human user and to provide natural language responses. It may also include a vision based input e.g. a camera and/or display screen. The digital device may include a language model or language generation neural network system either stored locally, or accessed remotely, or both. The user interface device may comprise, e.g., a mobile device, a keyboard (and optionally display), or a speech-based input mechanism, e.g. to input audio data characterizing a speech waveform of speech representing the input from the user in the natural or computer language and to convert the audio data into tokens representing the speech in the natural or computer language, i.e. representing a transcription of the spoken input. The user interface can also include a text or speech-based output, e.g. a display and/or a text-to-speech subsystem.

Thus in implementations the agent actions contribute to performing the task. A monitoring system, e.g. a video camera system, may be provided for monitoring the action (if any) which the user actually performs at each time step in case, e.g. due to human error, it is different from the action which the agent control system 100 instructed the user to perform. The monitoring system can be used to determine whether the task has been completed. Training data may be collected by record the actions which the user actually performed based on the instruction. The reward value of an action may be generated, for example, by comparing the action the user took with a corpus of data showing a human expert performing the task, e.g. using techniques known from imitation learning, or in some other way, e.g. using a trained reward model. A system of this type can learn how to guide a human to perform a task, e.g. avoiding difficult to perform actions.

Optionally, in any of the above implementations, the observation 108 at any given time step may include data from a previous time step that may be beneficial in characterizing the environment, e.g., the action performed at the previous time step, the reward received at the previous time step, or both.

To generate the one or more final policies 136 for use by the agent control system 100, the policy evaluation system 120 can first obtain or pre-generate a candidate policy set 130 that includes a plurality of candidate policies 134A-N for controlling an agent 104 to perform the particular task. Then, the policy evaluation system 120 performs a quantitative evaluation of each of the plurality of candidate policies 134A-N included in the candidate policy set 130 to generate a quantitative evaluation result for each candidate policy, and uses the quantitative evaluation results to determine the one or more final policies 136 for use by the agent control system 100 to select actions 102 for performance by the agent 104 when performing the particular task.

Typically, the agent control system 100 is local to the agent 104. For example, the agent control system 100 can be on-board the agent 104, e.g., can be implemented on one or more computers, a local workstation, or a local server having relatively small processing and memory resources that is on-board the agent 104.

In some implementations, the policy evaluation system 120 is local to the agent 104. For example, like the agent control system 100, the policy evaluation system 120 can also be on-board the agent 102. Moreover, in some of these implementations, the policy evaluation system 120 can be a part of the agent control system 100 which causes the agent 104 to perform actions 144. In these implementations, the agent control system 100 and the policy evaluation system 120 may be managed by the same organization.

In other implementations, the policy evaluation system 120 is remote from the agent 104. For example, unlike the agent control system 100, the policy evaluation system 120 can be hosted within a data center, which can be a distributed computing system having hundreds or thousands of computers in one or more locations. In these implementations, the agent control system 100 and the policy evaluation system 120 may be managed by different organizations.

The candidate policy set 130 includes multiple candidate policies 134A-N, where each candidate policy defines which action should be performed by the agent at each of multiple time steps (according to the candidate policy). The multiple candidate policies 134A-N reflect different approaches to performing the same particular task. Put another way, the multiple candidate policies 134A-N represent different solutions to the same technical problem of agent control.

One example of a candidate policy is a nontrainable action selection policy, e.g. an action selection policy that does not use neural network layers to select an action and/or which is non-differentiable. For example, the candidate policy can be a policy that, when used, consistently controls the agent to perform a same single action. As another example, the candidate policy can be a policy that selects actions with uniform randomness. As another example, the candidate policy can be a manually programmed policy that selects actions according to some hardcoded logic.

Another example of a candidate policy is a trainable action selection policy. In this example the candidate policy can be implemented as a trained candidate policy neural network which has been configured, e.g., using traditional reinforcement learning techniques, to, at each of multiple time steps, process a candidate policy network input that includes a current observation characterizing the current state of the environment, in accordance with learned values of the network parameters, to generate a candidate policy network output that specifies an action to be performed by the agent in response to the current observation.

As a more general example, the candidate policy can be any black box action selection policy, such that the policy evaluation system 120 need not have access to the internal workings of the action selection logics of the candidate policy. In the example where the candidate policy is implemented as a trained candidate policy neural network, the policy evaluation system 120 need not have access to the parameters or architecture of the trained candidate policy neural network.

The candidate policy set 130 can be obtained in any of a variety of ways. For example, the policy evaluation system 120 can receive data defining the candidate policies as an upload from a remote user of the system over a data communication network, e.g., using an application programming interface (API) made available by the system. As a particular example of this, the candidate policies can be provided by a third-party control policy developers, i.e., developers that are affiliated with neither the manufacturer of the agent 104 nor the organization that manages the policy evaluation system 120. As another example, the policy evaluation system 120 can receive an input from a user specifying which data that is already maintained by the system 120, or another system by the system, should be used as the data defining the candidate policies. As another example, the policy evaluation system 120 or another system can generate the candidate policies implemented as trained candidate policy neural networks using traditional reinforcement learning techniques.

To evaluate each of the plurality of candidate policies 134A-N, the policy evaluation system 120 includes or accesses a plurality of successor feature neural networks 150A-N and a performance prediction model 160. The policy evaluation system 120 also includes or accesses an offline dataset 140 that includes a plurality of history observations of the environment 106.

The plurality of successor feature neural networks 150A-N correspond respectively to the plurality of candidate policies 134A-N. That is, each successor feature neural network corresponds to a different candidate policy from the plurality of candidate policies 134A-N that can be used to control the agent 104 to perform the particular task. For example, in FIG. 1, successor feature neural network 150A corresponds to candidate policy 134A, successor feature neural network 150B corresponds to candidate policy 134B, and so on.

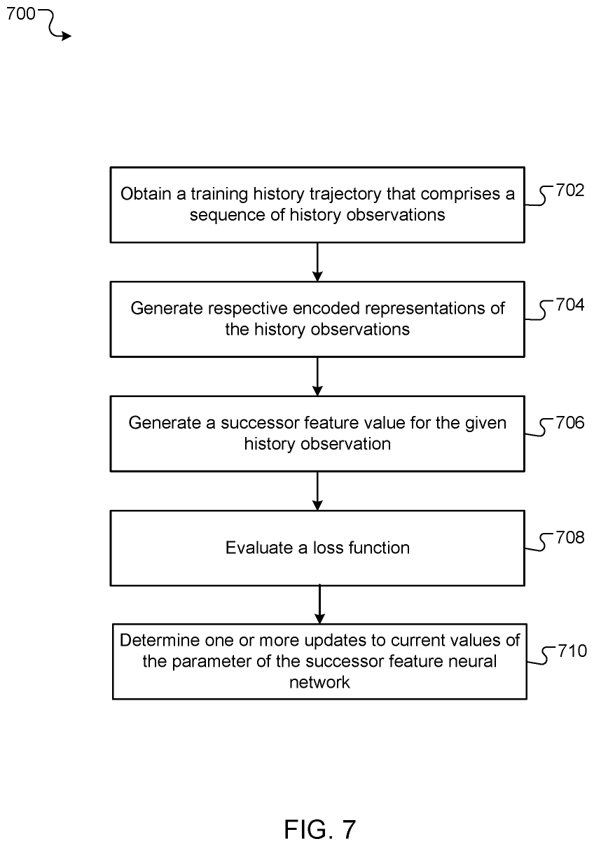

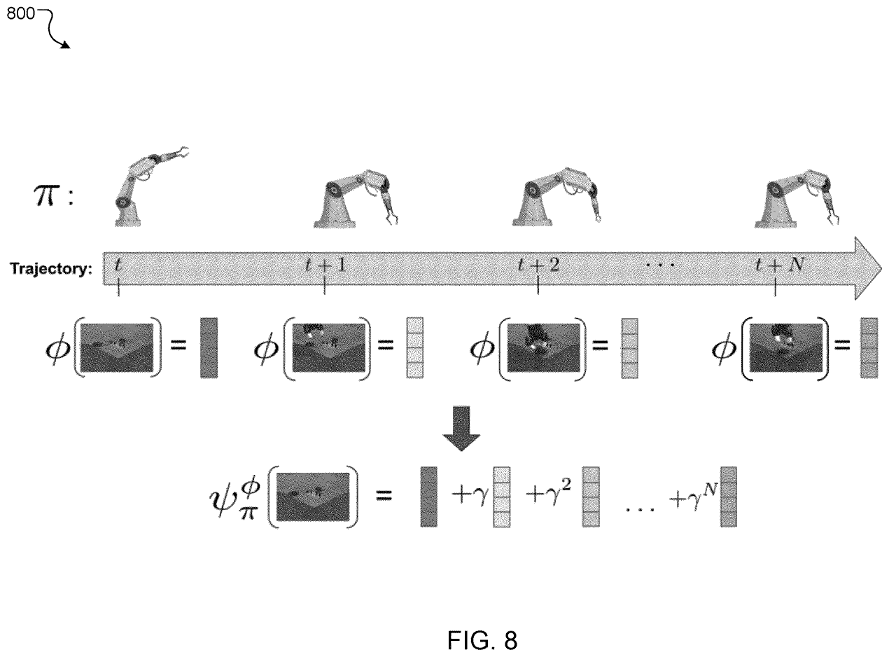

Each candidate policy neural network can have any appropriate architecture, e.g., feedforward or recurrent, such as comprising a multi-layer perceptron (MLP) with tanh activation layer(s) (or layer(s) with another choice of activation function), or a convolutional neural network, that allows the candidate neural network to map an observation to a candidate policy network output for selecting actions. In this example, the training of each candidate policy neural network can either take place locally at the policy evaluation system 120, or can alternatively take place at a remote, cloud-based training system. An example way of obtaining the successor feature neural networks 150A-N will be described in more detail below with reference to FIGS. 7-8.

For example, the candidate policy network output may be a probability distribution over the set of possible actions. As another example, the candidate policy network output may comprise a Q value that is an estimate of the long-term time-discounted reward that would be received if the agent performs a particular action in response to the observation. As another example, the candidate policy network output may identify a particular action, e.g., by defining the mean and variance of the torque to be applied to each of multiple movable components, e.g., joints, of a robot.

The offline dataset 140 stores experience data obtained as a consequence of the interaction of the agent 104 or another agent with the environment 106 or with another instance of the environment. Additionally or instead, the offline dataset 140 stores experience data derived from environment interaction information obtained from any of a variety of other relevant sources, e.g., driving logs in the case of the agent being an autonomous or semi-autonomous vehicle. Thus, the offline dataset 140 can be obtained before the candidate policies 134A-N are evaluated using the policy evaluation system 120.

For example, the agent may be controlled by the present action control system 100 or another control system, including by a human-operated or another machine learning-based control system, by a hard-coded policy that selects actions to be performed by the agent in accordance with pre-programmed logic, or simply by a random policy that selects actions with uniform randomness, and so on.

The experience data includes a plurality of history trajectories 144A-N. Each history trajectory, in turn, includes a plurality of history observations. Each history observation characterizes a history state of the environment 106 or another instance of the environment being interacted with by the agent 104 or the other agent.

In some implementations, the policy evaluation system 120 can similarly obtain the offline dataset 140, e.g., as an upload from a remote user of the system or from another system, while in other implementations, the policy evaluation system 120 can obtain the offline dataset 140 by controlling the agent 104 to interact with the environment 104 and then including the observations received by the system during the interaction in the offline dataset 140.

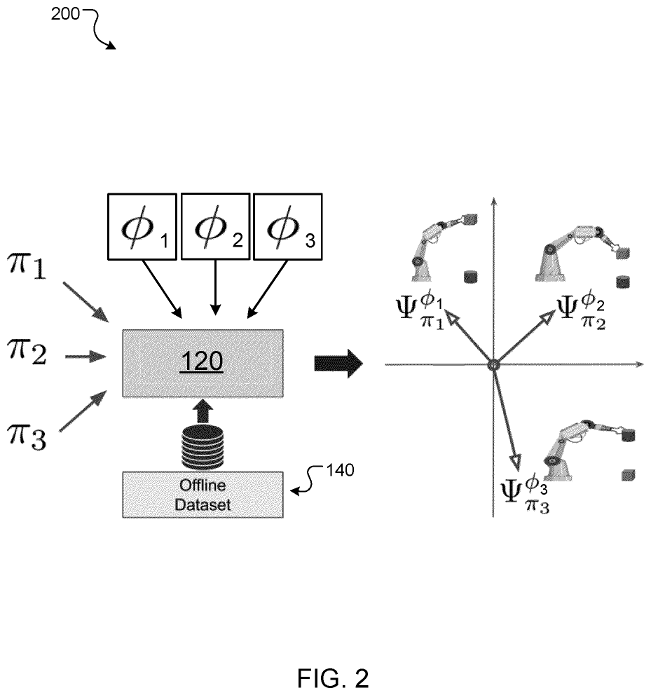

FIG. 2 is an example illustration 200 of operations performed by the policy evaluation system 120 to generate the quantitative evaluation result for each of the plurality of candidate policies 134A-N included in the candidate policy set 130. For each candidate policy, the quantitative evaluation result includes an estimated performance measure for the candidate policy, i.e., an estimate of the performance of the candidate policy when it is used to select actions to be performed by an agent to interact with an environment to perform a particular task.

The policy evaluation system 120 generates, for each candidate policy in the candidate policy set 130, a behavioral representation by using a successor feature neural network that corresponds to the candidate policy and by accessing the offline dataset 140. As used herein, a behavioral representation is a vector or another data structure of numeric values, e.g., floating point values or other values, having a pre-determined dimensionality, e.g., in a latent space.

More specifically, for each candidate policy in the candidate policy set 130, the policy evaluation system 120 can select a subset of the plurality of history observations by sampling, e.g., with uniform randomness, from all of the history observations stored in the offline dataset 140. Then, for each candidate policy in the candidate policy set 130, and for each selected history observation in the subset, the policy evaluation system 120 processes a successor feature network input that includes (i) the history observation (which in this particular example comprises visual state features) and (ii) data identifying a respective action that can be selected by using the candidate policy to be performed by the agent 104 in response to the history observation using successor feature neural network that corresponds to the candidate policy to generate a successor feature value of the history observation. As discussed below, the successor feature value may have a dimension greater than one in some cases, i.e. the feature value may be a N-dimensional vector, where N is the dimension of the successor feature value.

FIG. 2 thus illustrates that, for the first candidate policy π₁, the policy evaluation system 120 selects a subset of history observations s from the offline dataset 140, and, for each history observation s included in the subset, processes a successor feature network input that includes (i) the history observation s, (ii) data identifying a respective action that can be selected by using the first candidate policy π₁ to be performed by the agent 104 in response to the history observation, and, in some implementations, (iii) non-visual state features, e.g., proprioception information, or data derived from the non-visual state features, or both, using the first successor feature neural network φ₁ that corresponds to the first candidate policy π₁ to generate a successor feature value ψ_{π}_{₁}^{φ}^{₁}(s) of the history observation s. The successor feature value may be indicative of the expected future occurrence of states of the environment for the respective policy given the history observation(s).

The policy evaluation system 120 then combines the successor feature values that have been generated for the history observations s included in the subset to generate a feature vector ψ_{π}_{₁}^{φ}^{₁} for the for the first candidate policy π₁. The policy evaluation system 120 can do this in any suitable way. For example, the feature vector ψ_{π}_{₁}^{φ}^{₁} can be an average of the successor feature values that have been generated for the history observations s included in the subset. As another example, the feature vector ψ_{π}_{₁}^{φ}^{₁} can be a sum of the successor feature values that have been generated for the history observations s included in the subset.

In FIG. 2, the policy evaluation system 120 can similarly generate the feature vector ψ_{π}_{₂}^{φ}^{₂} for the second candidate policy π₂ and the feature vector ψ_{π}_{₃}^{φ}^{₃} for the third candidate policy π₃ by using the second successor feature neural network φ₂ that corresponds to the second candidate policy π₂ and the third successor feature neural network φ₃ that corresponds to the third candidate policy π₃, respectively, and by accessing the offline dataset 140.

The successor feature neural networks can generally have any appropriate neural network architecture that enables each of them to perform its described functions, i.e., to receive a successor feature network input that includes (i) a history observation, (ii) data identifying a respective action selected by using a candidate policy, and, in some implementations, (iii) non-visual state features, e.g., proprioception information, or data derived from the non-visual state features, or both, and to process the successor feature network input to generate the successor feature value of the history observation.

Generally, however, each successor feature neural network can be a neural network that includes multiple neural network components that cooperate to generate the successor feature value. For example, each successor feature neural network can include any appropriate number of layers (e.g., 5 layers, 10 layers, or 25 layers) of any appropriate type (e.g., fully connected layers, convolutional layers, attention layers, recurrent layers, etc.) and connected in any appropriate configuration (e.g., as a linear sequence of layers).

In some implementations, the successor feature neural networks 150A-N included in or accessed by the policy evaluation system 120 have the same architecture. For example, the successor feature neural networks 150A-N can have the same architecture but may have different parameter values. In other implementations, the architectures of successor feature neural networks 150A-N differ from one another. For example, the successor feature neural networks 150A-N in FIG. 1 can include different numbers of neural network layers, different kinds of neural network layers, or both.

A specific example architecture of the successor feature neural network will now be described.

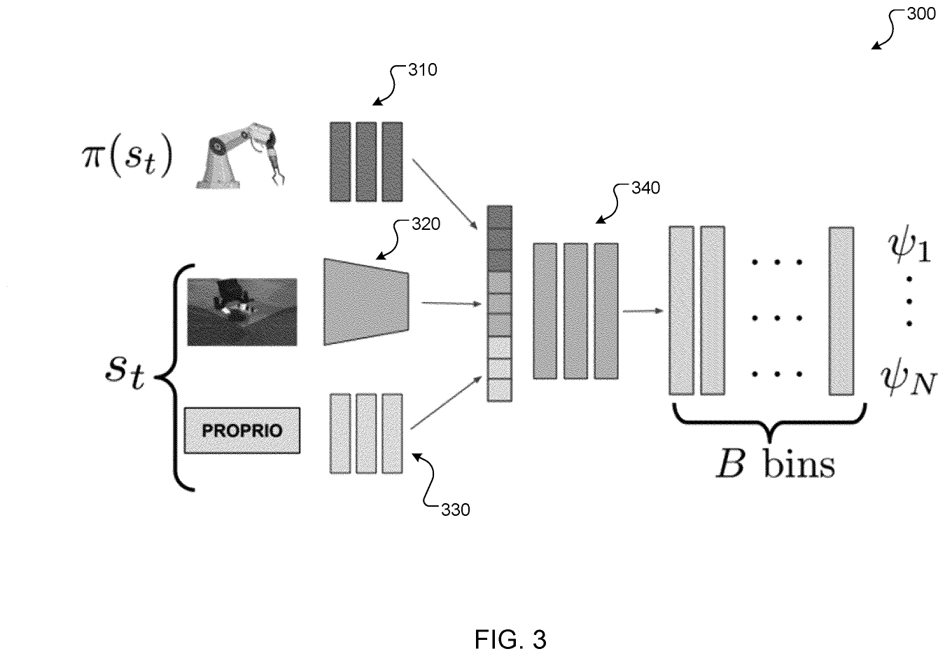

FIG. 3 is an illustration 300 of an example architecture of a successor feature neural network. Obtaining a successor feature neural network that has the example architecture shown in FIG. 3 or any other architecture will be discussed further below with reference to FIGS. 7-9.

In the example of FIG. 3, the successor feature neural network includes multiple embedding sub-networks 310, 320, 330 and a multilayer-perceptron sub-network 340. A sub-network of a neural network refers to a group of one or more neural network layers in the neural network.

The multiple embedding sub-networks include a first embedding sub-network 310 that is configured to process data that identifies a selected action to generate an action embedding. The multiple embedding sub-networks also include a second embedding sub-network 320 that is configured to process a history observation to generate a history observation embedding. Optionally, the multiple embedding sub-networks further include a third embedding sub-network 330 that is configured to process non-visual state features, or data derived from the non-visual state features, or both to generate a non-visual state feature embedding. For example, the non-visual state features can include proprioception information.

As one example, the first embedding sub-network 310 and the third embedding sub-network 330 can each be a respective fully-connected sub-network, i.e., that includes one or more fully-connected neural network layers. In some implementations, the first embedding sub-network 310 can be the same as the third embedding sub-network 330, i.e., the successor feature neural network uses a shared embedding sub-network to generate the action embedding and the non-visual state feature embedding.

The second embedding sub-network 320 can be, for example, a convolutional sub-network, i.e., that includes one or more convolutional neural network layers.

The multilayer-perceptron sub-network 340 includes one or more fully-connected neural network layers. The multilayer-perceptron sub-network 340 operates on a combination, e.g., a concatenation, of the (i) action embedding, (ii) the history observation embedding, and optionally, (iii) the non-visual state feature embedding to generate the successor feature value.

The successor feature value may be generated deterministically, e.g., by an output of the multilayer-perceptron sub-network 340, or stochastically, e.g., where the output of the multilayer-perceptron sub-network 340 parameterizes one or more distributions from which the successor feature value is sampled. As a particular example of the latter, the multilayer-perceptron sub-network 340 generates as output a vector of B×N dimensions, where B is the number of bins (or intervals) of the distribution and N is the dimension of the successor feature value.

For each of the plurality of candidate policies 134A-N included in the candidate policy set 130, after having generated the feature vector for the candidate policy in this way, the policy evaluation system 120 then determines the behavioral representation for the candidate policy from the feature vector.

In some implementations, the feature vector that is generated by combining, e.g., averaging or summing, the successor feature values generated by the successor feature neural network is directly used by the policy evaluation system 120 as the behavioral representation for the candidate policy. In other implementations, the feature vector is further processed by the policy evaluation system 120 to provide the behavioral representation. For example, one or more linear or non-linear neural network layers can be used to process the feature vectors to generate the behavioral representations.

After having generated the behavioral representations, the policy evaluation system 120 determines, for each of the plurality of candidate policies 134A-N included in the candidate policy set 130, an estimated performance measure for the candidate policy based on the behavioral representation for the candidate policy.

In particular, the policy evaluation system 120 can do this by, for each candidate policy, processing the behavioral representation for the candidate policy using the return estimation model 160 to generate an estimated return of the candidate policy, e.g., an estimated return of the candidate policy from a state of the environment characterized by the history observation(s). The estimated return is then used as the estimated performance measure for the candidate policy.

The return estimation model 160 have any appropriate architecture that allows the model 160 to map an input that includes the behavioral representation to an estimated return. For example, the return estimation model 160 can be a linear model, i.e., a model that multiples the input to the model by a parameter matrix and, optionally, then adds a bias value to the product to generate the estimated return. As another example, the return estimation model 160 can be a neural network model that processes the input to the model through multiple neural network layers to generate the estimated return.

In either example, such a return estimation model 160 can, in some implementations, be trained on training data that includes a plurality of training tuples that each specify (i) a behavioral representation for an action selection policy that can be used to select an action to be performed by an agent, e.g., in response to an observation characterizing a state of the environment and (ii) a reward received by the agent after the action selected by the action selection policy has been performed in response to the observation, based on optimizing a loss function that evaluates, for each training tuple, a difference between (i) an estimated return generated by the model based on processing the behavioral representation and (ii) the reward specified by the training tuple.

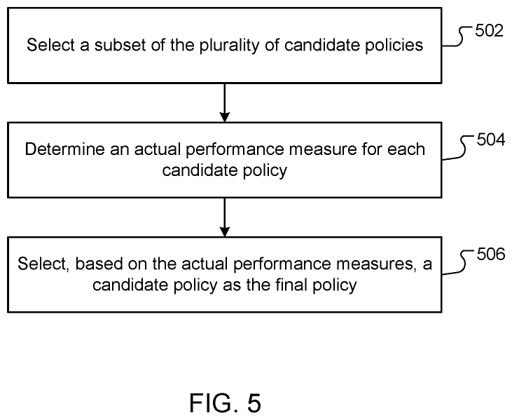

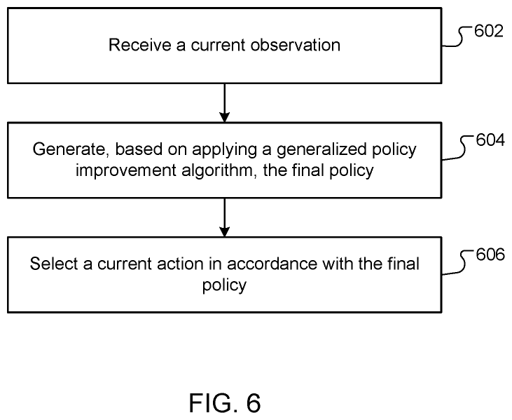

After having generated the estimated performance measure for each candidate policy, the policy evaluation system 120 obtains the one or more final policies 136 for controlling the agent 104 to perform the particular task in the environment 106 based on the plurality of candidate policies 134A-N included in the candidate policy set 130, and their estimated performance measures. There are many ways in which the policy evaluation system 120 can do this, as will be discussed further below with reference to FIGS. 5-6.

In some implementations, the policy evaluation system 120 provides data specifying a final policy 136 to the agent control system 100-and the agent control system 100 deploys the final policy 136 and uses the final policy 136 to control the agent 104 interacting with the environment 106 by, at each of multiple time steps throughout a trajectory, using the final policy to select an action 102 to be performed by the agent 104. For example, such a final policy 136 generated by the policy evaluation system 120 will be used to select actions at different time steps throughout the trajectory.

A trajectory represents a sequence of interactions of the agent 104 with the environment 106 over a sequence of time steps. For example, a trajectory can represent an episode of the specified task over a sequence of time steps during which the agent attempts to perform the specified task. For example, the task episode can continue for a predetermined number of time steps or until a reward is received that indicates that the task has been successfully completed.

In addition, in some implementations, the policy evaluation system 120 can provide data specifying the final policy 136 for use in controlling the agent to perform the particular task that has been generated by the policy evaluation system 120 to another system, e.g., another agent control system, such that the other system can store the final policy for some other purposes, e.g., can modify the final policy for use in selecting actions to be performed by the agent to perform other tasks. In some implementations, the agent control system 100 can also output the estimated performance measures to the users or systems that provided the candidate policies 134A-N.

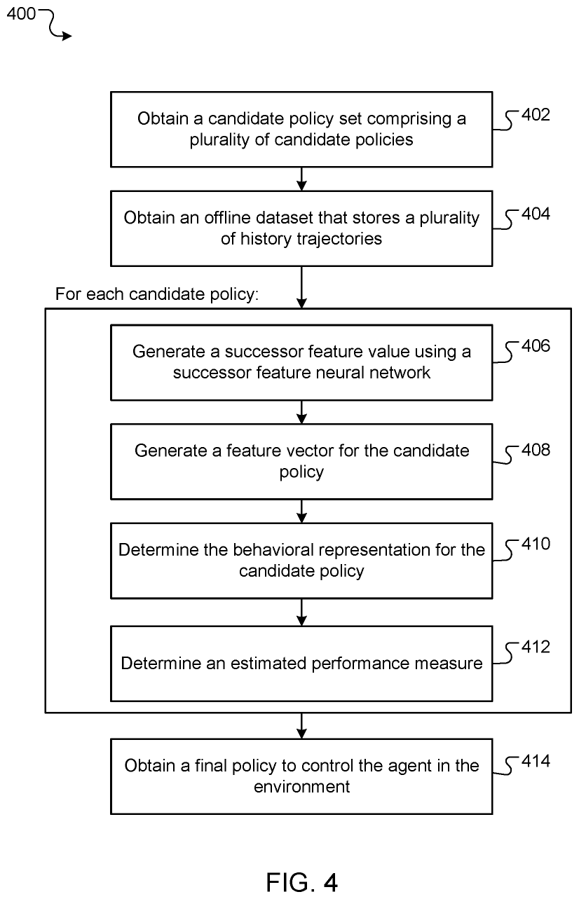

FIG. 4 is a flow diagram of an example process 400 for controlling an agent in an environment. For convenience, the process 400 will be described as being performed by a system of one or more computers located in one or more locations. For example, a policy evaluation system, e.g., the policy evaluation system 120 of FIG. 1, appropriately programmed, can perform the process 400.

The system obtains a candidate policy set that includes a plurality of candidate policies (step 402). Each candidate policy defines which action should be performed by the agent at each of multiple time steps (according to the candidate policy). The plurality of candidate policies can include nontrainable action selection policies, e.g., a random action selection policy or an action selection policy defined by hardcoded logic, trainable action selection policies, e.g., a candidate policy implemented as a trained candidate policy neural network that can map an observation to data that specified an action to be performed by the agent in response to the observation, or both nontrainable and trainable action selection policies.

The system obtains an offline dataset that is generated as a consequence of the interaction of the agent or another agent with the environment or with another instance of the environment (step 404). Each history trajectory includes a plurality of history observations. Each history observation characterizes a respective history state of the environment. For example, each history observation can correspond to a particular time during a task episode and may comprise visual state features of the environment and/or non-visual state features of the environment.

The system then performs following steps 406-412 to generate an estimated performance measure for each candidate policy. In other words, by repeatedly performing multiple iterations of steps 406-412, the system can generate respective estimated performance measures for the plurality of candidate policies included in the candidate policy set.

For each of a subset of the plurality of history observations, the system generates a successor feature value for the history observation under the candidate policy by using a successor feature neural network that corresponds to the candidate policy (step 406).

The system can obtain the subset of the plurality of history observations by sampling, e.g., with uniform randomness, from all of the history observations stored in the offline dataset. By sampling from the offline dataset, the system generally selects different history observations for different candidate policies across the multiple iterations of steps 406-412.

Moreover, the system maintains a plurality of successor feature neural networks that each correspond to a respective one of the candidate policies, and uses different successor feature neural networks for different candidate policies across the multiple iterations of steps 406-412.

For each of the subset of the plurality of history observations, the successor feature neural network is configured to receive a successor feature network input that includes (i) the history observation, (ii) data identifying a respective action that can be selected by using the candidate policy to be performed by the agent in response to the history observation, and, in some implementations, (iii) non-visual state features, e.g., proprioception information, or data derived from the non-visual state features, or both, and process the successor feature network input to generate the successor feature value of the history observation.

The system generates a feature vector for the candidate policy based on combining, e.g., averaging or summing, the successor feature values that have been generated for the subset of the plurality of history observations (step 408).

The system determines the behavioral representation for the candidate policy from the feature vector for the candidate policy (step 410). In some implementations, the feature vector is directly used by the system as the behavioral representation for the candidate policy, while in other implementations, the feature vector is further processed by the system to provide the behavioral representation. For example, one or more linear or non-linear neural network layers can be used to process the feature vectors to generate the behavioral representations.

The system determines, based on the behavior representation for the candidate policy, an estimated performance measure for the candidate policy (step 412). The system can do this by processing the behavioral representation using a return estimation model to generate an estimated return of the candidate policy, and then using the estimated return as the estimated performance measure for the candidate policy.

In some cases, the plurality of candidate policies includes at least one already evaluated candidate policy, i.e., a candidate policy that has a known estimated performance measure. For example, the candidate policy set can include a greater number of candidate policies that have not been evaluated than candidate policies that have already been evaluated, e.g., the candidate policy can include 100, 200 or more unevaluated candidate policies and no more than 5 already been evaluated candidate policies.

In these cases, for each remaining candidate policy in the candidate policy set that has not been evaluated, the system can determine the estimated performance measure for the remaining candidate policy based on (a) a difference between (i) an estimated behavioral representation for the remaining candidate policy and (ii) a behavioral representation for the already evaluated candidate policy and on (b) the known performance measure of the already evaluated candidate policy. For example, the greater the difference (e.g., in terms of a distance in the latent space) between the behavioral representations, the greater the difference between the estimated performance measure for the remaining candidate policy and the known performance measure of the already evaluated candidate policy. Doing so can enable the system to quickly and more accurately determine the estimated performance measures for a very large, potentially infinitely large, number of candidate policies from a relatively small number of already evaluated candidate policy.

After having repeatedly performed multiple iterations of steps 406-412 to generate the estimated performance measures for the plurality of candidate policies included in the candidate policy set, the system proceeds to obtain a final policy to control the agent in the environment based on the plurality of candidate policies and the estimated performance measure for each of the plurality of candidate policies (step 414). There are many ways in which the system can obtain such a final policy based on the estimated performance measures.

An example way in which the system can obtain the final policy is described in more detail below with reference to FIG. 5.

FIG. 5 is a flow diagram of sub-steps 502-506 of the step 414 of the process 400 according to one implementation.

The system selects a subset of the plurality of candidate policies based on their estimated performance measures (step 502). For example, the system can select one or more candidate policies that have the highest estimated performance measures among the estimated performance measures of all candidate policies included in the candidate policy set. As another example, the system can select one or more candidate policies that have estimated performance measures that satisfy, e.g., are greater than, a given threshold performance measure.

The system determines an actual performance measure for each candidate policy in the subset by using the candidate policy to control the agent in the environment (step 504). That is, for each candidate policy in the subset, the system controls the agent to interact with the environment by selecting an action to be performed by the agent in accordance with the candidate policy at each of multiple time steps, e.g., at each of a fixed number of time steps. The system monitors the return received by the agent over the multiple time steps, and then determines the actual performance measure for the candidate policy based on the returns, e.g., as a cumulative return received by the agent over the multiple time steps.

The system selects, based on the actual performance measures, a candidate policy as the final policy for controlling the agent to perform the particular task in the environment (step 506). For example, the system can select the candidate policy that has the highest actual performance measure among the actual performance measures of all candidate policies in the subset.

In this example, after having selected a candidate policy as the final policy, the system or another agent control system can then deploy the final policy and then use the final policy to control the agent interacting with the environment by, at each of multiple time steps throughout a trajectory, using the final policy to select an action to be performed by the agent.

In particular, in this example, the number of candidate policies in the proper subset is generally much smaller than the total number of candidate policies in the candidate policy set. For example, even when the candidate policy set includes 100, 500 or more candidate policies, the system can still accurately control the agent with only 10 candidate policies being included in the subset, i.e., with 10 candidate policies being used to generate the final policy.

This allows the system to evaluate the performance of different candidate policies with reduced latency and while consuming fewer computational resources than conventional offline policy selection approaches. When using the candidate policies to actually control a real-world agent in a real-world environment is required for the sake of performance evaluation of the candidate policies, because only a small number of the candidate policies will need to be evaluated, i.e., used to select the actions to be performed by the agent, this can avoid unnecessary wear and tear on and damage to the real-world environment or the real-world agent or both.

Another example way in which the system can obtain the final policy is described in more detail below with reference to FIG. 6.

FIG. 6 is a flow diagram of sub-steps 602-606 of the step 414 of the process 400 according one implementation.

The system receives a current observation characterizing a current state of the environment (step 602).

The system generates the final policy based on applying a policy improvement algorithm, such as a generalized policy improvement algorithm, to the plurality of candidate policies in accordance with their estimated performance measures (step 604). By applying a (generalized) policy improvement algorithm, the system can generate, as the final policy, a composite policy from two or more candidate polices in the set of candidate policies. The composite policy can be an action selection policy that switches between using a subset of the candidate policies with a given switching probability. When used, the composite policy defines, at each of multiple time steps, which one (and at most one) of the candidate policies will be used to control the agent in accordance with the given switching probability, and subsequently selects an action to be performed by the agent in accordance with the determined candidate policy.

For example, to generate the composite policy, the system can apply any one of the generalized policy improvement techniques that are described in Barreto, A., et al., Successor features for transfer in reinforcement learning in Advances in Neural Information Processing Systems, 2017, and in Thakoor, S., et al., Generalised Policy Improvement with Geometric Policy Composition in International Conference on Machine Learning. PMLR, 2022, to identify which candidate policies should be included in the subset, as well as how to switch from one of the candidate policies in the subset to another.

Like the example discussed above, after having generated a composite policy as the final policy, the system or another agent control system can then deploy the final policy and then use the final policy to control the agent interacting with the environment by, at each of multiple time steps throughout a trajectory, using the final policy to select an action to be performed by the agent, e.g., in response to the current observation received at the time step (step 606).

Because obtaining a plurality of successor feature neural networks that each correspond to a respective one of the candidate policies can be computationally intensive and consumes a significant amount of computational resources when there exists a large number of candidate policies, techniques for training a successor feature neural network for each candidate policy in a computationally efficient manner will now be discussed.

FIG. 7 is a flow diagram of an example process 700 for training a successor feature neural network that corresponds to a candidate policy. For convenience, the process 700 will be described as being performed by a system of one or more computers located in one or more locations. For example, a system, e.g., the agent control system 100 of FIG. 1 or another training system, appropriately programmed, can perform the process 700.

Prior to performing iterations of the process 700, the system obtains an offline dataset and data that specifies an encoder neural network. The offline dataset stores a plurality of history trajectories obtained as a consequence of the interaction of the agent or another agent with the environment or with another instance of the environment.

The encoder neural network can be, or be included in, a neural network having any appropriate architecture. Generally, however, the system uses the same encoder neural network across the multiple iterations of the process 700 to train different successor feature neural networks that correspond respectively to different candidate policies (although in some cases different encoder neural networks can be used). That is, the encoder neural network is agnostic to any particular candidate policy, can be broadly applied to any of a variety of candidate policies.

For example, the encoder neural network can be a convolutional neural network that includes one or more convolutional layers. The parameters of the encoder neural network can either have randomly initialized values, or alternatively have learned parameter values.

As another example, the encoder neural network can be an image encoder neural network that is included as a part of a multi-modal neural network, e.g., an image-text neural network, that has been pre-trained on a multi-modal task, e.g., a task that requires processing both text and image data to generate an output for the task, e.g., an image caption task.

As another example, the encoder neural network can be a visual Transformer (ViT) neural network that has been pre-trained on a computer vision task, e.g., an image classification task, an image embedding generation task, an object detection task, an image segmentation, and so on.

As another example, the encoder neural network can be a video processing neural network that has been pre-trained on a video tracking task or an action recognition task.

As yet another example, the encoder neural network can be, or be included in, a pre-trained model, such as a pre-trained foundation model. The pre-trained model can, for example, be a model that that has been trained using a self-supervised training method. A pre-trained “foundation” model refers to a model that has been pre-trained on (broad) data, e.g., using self-supervision at scale, that can be adapted to a wide range of downstream tasks. For example, a pre-trained foundation model may be typically be pre-trained to perform one or more tasks and then later adapted or augmented to perform one or more tasks that were not part of the pre-training. For example, the pre-trained foundation can be any one of the pre-trained visual foundation models mentioned in Rishi Bommasani, et al. On the opportunities and risks of foundation models, arXiv preprint arXiv: 2108.07258, 2021.

The system obtains, e.g., through sampling, a history trajectory from the offline dataset (step 702). The history trajectory includes a plurality of history observations. Each history observation characterizes a respective history state of the environment. The plurality of history observations included in the history trajectory can include a temporal sequence of history observations. The plurality of history observations are referred to as a temporal sequence because the history observations are arranged according to the order in which the corresponding observations were generated.

For each history observation in the temporal sequence of history observations that begins from a given history observation, the system processes an encoder network input that includes the history observation using the encoder neural network to generate a respective encoded representation of the history observation (step 704).

The system processes a successor feature network input that includes (i) the given history observation, (ii) data identifying a respective action that can be selected by using the candidate policy to be performed by the agent in response to the given history observation, and, in some implementations, (iii) non-visual state features, using the successor feature neural network to generate a successor feature value for the given history observation (step 706).

The system evaluates a loss function that measures a difference between (i) the successor feature value for the given history observation and (ii) a time-discounted sum of the respective encoded representations of the sequence of history observations that begins from the given history observation (step 708). For example, the loss function can be a squared loss function, a mean squared error loss function, or the like.

FIG. 8 is an example illustration 800 of training a successor feature neural network on a history trajectory. The history trajectory includes a temporal sequence of N history observations, e.g., a history observation at time t, a history observation at time t+1, a history observation at time t+2, and so on, up to a history observation at time t+N.

Suppose, for example, the given history observation in the example of FIG. 8 is history observation at time t, then the system can process each history observation in the temporal sequence of history observations that begins from a given history observation using an encoder neural network φ to generate a respective encoded representation of the history observation. The system computes a time-discounted sum ψ_{π}^{φ} of the respective encoded representations of the sequence of history observations that begins from the history observation at time t (where γ is the discount factor). The system evaluates a loss function that measures a difference between (i) the successor feature value for the given history observation that is generated by the successor feature neural network and (ii) the time-discounted sum ψ_{π}^{φ}.

The system determines one or more updates to current values of the parameter of the successor feature neural network (step 710). The system can do this by computing respective gradients of the loss function with respect to the parameters of the successor feature neural network by backpropagation through the appropriate parameters of the successor feature neural network. The system can then determine the updates by applying an update rule, e.g., an Adam update rule, an RMSProp update rule, or a stochastic gradient descent (SGD) update rule, to the respective gradients.

The system can repeatedly perform iterations of the process 700 on different history trajectories sampled from the offline dataset to update the parameters of the successor feature neural network.

For each candidate policy, the system can continue performing iterations of the process 700 until termination criteria for the training of the successor feature neural network that corresponds to the candidate policy have been satisfied, e.g., until the parameters have converged, until a threshold amount of wall clock time has elapsed, or until a threshold number of iterations of the process 700 have been performed.

By repeatedly performing iterations of the process 700 for different candidate policies, the system can obtain a plurality of trained successor feature neural networks that each corresponds to a different one of the plurality candidate policies. Because the system can perform iterations of the process 700 by leveraging the same encoder neural network and by accessing the same offline dataset, however, training different encoder neural networks and obtaining different offline datasets for different candidate policies and the associated cost can be avoided. Moreover, in some implementations, the system parallelizes the training of the successor feature neural networks to decrease the overall training time.

After the successor feature neural networks has been trained, they can be used in any suitable way. Merely as an example, the system can use a trained successor feature neural network that corresponds to a candidate policy to generate a behavioral representation of the candidate policy. In this example, the system can further use the behavioral representation of the candidate policy to determine whether to deploy the candidate policy for controlling an agent in the environment, or whether to use the candidate policy to generate a final policy for controlling the agent.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method comprising:
obtaining a candidate policy set comprising a plurality of candidate policies for controlling an agent in an environment;
obtaining an offline dataset that stores a plurality of history trajectories, wherein each history trajectory comprises a plurality of history observations that each characterize a respective history state of the environment; and
generating a behavioral representation for each candidate policy, comprising, for each candidate policy:
for each of a subset of the plurality of history observations, generating a successor feature value for the history observation under the candidate policy by using a successor feature neural network that corresponds to the candidate policy, wherein the successor feature neural network is configured to receive a successor feature network input comprising the history observation and a respective action selected by using the candidate policy to be performed by the agent in response to the history observation, and to process the successor feature network input to generate the successor feature value of the history observation;
generating a feature vector for the candidate policy based on the successor feature values that have been generated for one or more of the subset of the plurality of history observations; and
determining the behavioral representation for the candidate policy from the feature vector for the candidate policy.

2. The method of claim 1, wherein generating the feature vector for the candidate policy comprises computing an average of the successor feature values that have been generated for one or more of the subset of the plurality of history observations.

3. The method of claim 1, further comprising:
determining, based on the behavioral representation for each candidate policy, an estimated performance measure for each candidate policy

4. The method of claim 3, wherein determining the estimated performance measure for each candidate policy comprises:
processing the behavioral representation for the candidate policy using a learned model to generate, as the estimated performance measure, an estimated return of the candidate policy.

5. The method of claim 3, wherein the plurality of candidate policies comprise at least one already evaluated candidate policy, and wherein determining the estimated performance measure for each candidate policy comprises, for each remaining candidate policy that has not been evaluated:
determining the estimated performance measure for the remaining candidate policy based on (a) a difference between (i) a behavioral representation for the remaining candidate policy and (ii) a behavioral representation for the already evaluated candidate policy and on (b) a known performance measure of the already evaluated candidate policy.

6. The method of claim 5, wherein the plurality of candidate policies comprises a larger number of candidate policies that have not been evaluated than already evaluated candidate policies.

7. The method of claim 3, further comprising:
obtaining, based on the estimated performance measure for each candidate policy, a final policy to control the agent in the environment.

8. The method of claim 7, wherein obtaining the final policy to control the agent in the environment comprises:
selecting a subset of the plurality of candidate policies based on their estimated performance measures;
determining an actual performance measure for each candidate policy in the subset by using the candidate policy to control the agent in the environment, including selecting a sequence of actions to be performed by the agent in accordance with the candidate policy; and
selecting, based on the actual performance measures, a candidate policy as the final policy.

9. The method of claim 7, wherein obtaining the final policy to control the agent in the environment comprises:
receiving a current observation characterizing a current state of the environment;
generating, based on applying a generalized policy improvement algorithm to the plurality of candidate policies, the final policy; and
selecting a current action to be performed by the agent in response to the current observation in accordance with the final policy.

10. The method of claim 1, further comprising training different successor feature neural networks that correspond to different candidate policies by using an encoder neural network and by using the offline dataset.

11. The method of claim 10, wherein training a successor feature neural network that corresponds to a candidate policy comprises:
obtaining from the offline dataset a training history trajectory that comprises a sequence of history observations;
processing each history observation in the sequence of history observations that begins from a given history observation using the encoder neural network to generate a respective encoded representation of the history observation;
processing the given history observation in the sequence of history observations using the successor feature neural network to generate a successor feature value for the given history observation;
evaluating a loss function that measures a difference between (i) the successor feature value for the given history observation and (ii) a time-discounted sum of the respective encoded representations of the sequence of history observations that begins from the given history observation; and
determining, based on computing a gradient of the loss function with respect to parameters of the successor feature neural network, one or more updates to current values of the parameter of the successor feature neural network.

12. The method of claim 10, wherein the encoder neural network comprises one of:
a convolutional neural network having randomly initialized or learned parameter values;
an image encoder in an image-text neural network pre-trained on an image caption task;
a visual Transformer neural network pre-trained on an image classification task; or
a neural network pre-trained on a video tracking task.

13. A computer-implemented method comprising:
obtaining data specifying a pre-trained model;
maintaining an offline dataset that stores a plurality of history trajectories, wherein each history trajectory comprises a plurality of history observations that each characterize a respective history state of an environment; and
training a successor feature neural network that corresponds to a candidate policy by using the pre-trained model and the offline dataset, wherein the training comprises:
obtaining from the offline dataset a training history trajectory that comprises a sequence of history observations;
for each history observation in the sequence of history observations that begins from a given history observation, processing a model input comprising the history observation using the pre-trained model to generate a respective encoded representation of the history observation;
processing a successor feature network input comprising (i) the given history observation in the sequence of history observations and (ii) an action selected using the candidate policy in response to the given history observation using the successor feature neural network to generate a successor feature value for the given history observation;
evaluating a loss function that measures a difference between (i) the successor feature value for the given history observation and (ii) a time-discounted sum of the respective encoded representations of the sequence of history observations that begins from the given history observation; and
determining, based on computing a gradient of the loss function with respect to parameters of the successor feature neural network, one or more updates to current values of the parameter of the successor feature neural network.

14. The method of claim 13, further comprising using the trained successor feature neural network to generate a behavioral representation of the candidate policy.

15. The method of claim 14, further comprising using the behavioral representation of the candidate policy to determine whether to deploy the candidate policy for controlling an agent in the environment or whether to use the candidate policy to generate a final policy for controlling the agent.

16. The method of claim 13, wherein the pre-trained model comprises a pre-trained visual model.

17. The method of claim 1, wherein the agent is a mechanical agent and the environment is a real-world environment.

18. The method of claim 17, wherein the agent is a robot.

19. The method of claim 1, wherein the environment is a real-world environment of a service facility comprising a plurality of items of electronic equipment and the agent is an electronic agent configured to control operation of the service facility.

20. The method of claim 1, wherein the environment is a real-world manufacturing environment for manufacturing a product and the agent comprises an electronic agent configured to control a manufacturing unit or a machine that operates to manufacture the product.

21. The method of claim 1, wherein the environment is a simulation of a real-world environment and wherein the method further comprises:
after generating the final policy, providing data specifying the final policy for use in controlling a real-world agent in the real-world environment.

22. A system comprising one or more computers and one or more storage devices storing instructions that are operable, when executed by the one or more computers, to cause the one or more computers to perform operations comprising:
obtaining a candidate policy set comprising a plurality of candidate policies for controlling an agent in an environment;
obtaining an offline dataset that stores a plurality of history trajectories, wherein each history trajectory comprises a plurality of history observations that each characterize a respective history state of the environment; and
generating a behavioral representation for each candidate policy, comprising, for each candidate policy:
for each of a subset of the plurality of history observations, generating a successor feature value for the history observation under the candidate policy by using a successor feature neural network that corresponds to the candidate policy, wherein the successor feature neural network is configured to receive a successor feature network input comprising the history observation and a respective action selected by using the candidate policy to be performed by the agent in response to the history observation, and to process the successor feature network input to generate the successor feature value of the history observation;
generating a feature vector for the candidate policy based on the successor feature values that have been generated for one or more of the subset of the plurality of history observations; and
determining the behavioral representation for the candidate policy from the feature vector for the candidate policy.

23. (canceled)
